(19) United States
(12) Patent Application Publication
(10) Pub. No.: US 2023/0334366 A1
(43) Pub. Date: Oct. 19, 2023

(54) SYSTEM AND METHODS FOR UTILIZING PREDICTIONS OF FUTURE REAL-WORLD EVENTS TO GENERATE ACTIONABLE DECISIONS

(71) Applicant: X Development LLC, Mountain View, CA (US)

(72) Inventors: Joshua Paul Jeffery, Ben Lomond, CA (US); Callum Woolley, New York, NY (US)

(21) Appl. No.: 18/184,830

(22) Filed: Mar. 16, 2023

Related U.S. Application Data
(60) Provisional application No. 63/331,456, filed on Apr. 15, 2022.

(51) Int. Cl. G06N 20/00

(52) U.S. Cl. CPC G06N 20/00

(57) ABSTRACT

Methods, systems, and apparatus for utilizing predictions of future real-world events to generate actionable decisions. In some implementations, a computer can obtain a plurality of prediction results in association with an event from a machine learning model. The computer can receive from semantic information from a user device. The computer can match one or more prediction results of the plurality of prediction results to the semantic information. The computer can generate one or more actionable outputs by processing the one or more prediction results and the semantic information for the user device. The computer can forward the one or more actionable outputs to the user device, wherein the one or more actionable outputs comprise information that allows a user of the user device to act on in advance of occurrence of the event.

### CROSS-REFERENCE TO RELATED APPLICATION

This application claims the benefit of U.S. Provisional Application No. 63/331,456 filed on Apr. 15, 2022, and titled “System and Methods for Utilizing Predictions of Future Real-World Events to Generate Actionable Decisions,” which is incorporated herein by reference.

### TECHNICAL FIELD

This specification relates generally to data processing and data analysis.

### BACKGROUND

Natural events or conditions such as wildfires or seasonal vegetation growth can greatly impact people's daily life and entities' operation thus their associated needs for products and/or services as well as the ability of providers to provision products and/or services. Natural disasters are increasing in both frequency and intensity. Example natural disasters can include wildfires, hurricanes, tornados, and floods, among several others. Natural disasters often result in significant loss that can include a spectrum of economic losses, property losses, and physical losses (e.g., deaths, injuries). Consequently, significant time and effort is expended not only predicting occurrences of natural disasters, but characteristics of natural disasters such as duration, severity, spread, and the like. For example, in an event of extreme heat waves, the affected area will experience a significantly increased demand for ice, cool beverages, fans, air conditioners, and/or on-ground swimming pools. Such volatile needs may lack predictability thereby posing challenges on product inventories, manpower and equipment for production, and other supply chain functionalities.

Technologies, such as artificial intelligence (AI) and machine learning (ML), have been leveraged to generate predictions around natural disasters. ML models can employ multiple layers of operations to predict one or more outputs from one or more inputs. ML models can be trained by processing historical data associated with natural events or conditions to make predictions with a degree of accuracy of future real-world events or conditions. However, natural disasters present a special use case for predictions using ML models, which results in technical problems that must be addressed to generate reliable and actionable predictions.

### SUMMARY

This specification describes systems, methods, devices, and other techniques relating to utilizing machine learning (ML) to gain insights about utilizing prediction results of future real-world events to provide users with actionable information that can prepare the users based on user-specified semantic information and in advance of occurrence of the events.

In one general aspect, a method is performed by a computer for utilizing predictions of future real-world events to make actionable decisions that prepare users for the real-world events. The method includes: obtaining, by a computer and from a machine learning model, a plurality of prediction results in association with an event; receiving, by the computer and from a user device, semantic information; matching, by the computer, one or more prediction results of the plurality of prediction results to the semantic information; generating, by the computer for the user device, one or more actionable outputs by processing the one or more prediction results and the semantic information; and forwarding, by the computer to the user device, the one or more actionable outputs, wherein the one or more actionable outputs comprise information that allows a user of the user device to act on in advance of occurrence of the event.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, the method includes wherein each of the plurality of prediction results comprises one or more parameters of: (1) the event; (2) a time window that the event occurs; (3) a geospatial area that the event occurs; (4) an intensity of the event; and (5) a probability of occurrence of the event corresponding to one or more of (2), (3), and (4).

In some implementations, the method includes wherein matching, by the computer, the one or more prediction results of the plurality of prediction results to the semantic information is based on a predetermined mapping relationship between the plurality of prediction results and the semantic information.

In some implementations, the method includes wherein generating, by the computer for the user device, one or more actionable outputs by processing the one or more prediction results and the semantic information, comprises: providing the one or more prediction results and the semantic information to a trained machine learning model; and receiving an output from the trained machine learning model, including the one or more actionable outputs.

In some implementations, the method includes wherein the one or more actionable outputs is automatically executed by the user device.

In some implementations, the method includes wherein the one or more actionable outputs is displayed by the user device to a user using a graphic user interface (GUI).

In some implementations, the method includes wherein the event comprises a natural event or condition.

In some implementations, the method includes wherein the natural event or condition comprises a natural hazardous event.

In some implementations, the method includes wherein the semantic information comprises information corresponding to a product, a service, and/or a provider thereof.

In some implementations, the method includes wherein obtaining, by the computer and from the machine learning model, the plurality of prediction results in association with the event is based on the semantic information.

In some implementations, the method includes wherein generating the one or more actionable outputs by processing the one or more prediction results and the semantic information is in response to determining that at least one of the one or more parameters of the event satisfies a predetermined threshold.

In some implementations, the method includes wherein matching, by the computer, the one or more prediction results of the plurality of prediction results to the semantic information is by calculating a correlation between historical events and historical data in correspondence to the semantic information.

In some implementations, the method includes wherein matching, by the computer, the one or more prediction results of the plurality of prediction results to the semantic information is by using a machine learning model trained on historical events and historical data in correspondence to the semantic information.

Particular implementations of the subject matter described in this specification can be executed so as to realize one or more of the following advantages. The systems and methods herein provide a technical solution to utilizing predictions of future real-world events or conditions in connection with semantic information so that users can prepare for urgent and unmet need for products and services (e.g., with supply chain adjustment) in advance of such events. An entity (or a user), in order to be prepared for unexpected natural events or conditions, can inquire the systems and methods disclosed herein for recommendations in relation to its services and/or products. Such recommendations can be made for a future time window and/or a geo-spatial region to facilitate the user in making actionable decisions that can prepare the user in advance for the natural events or conditions. For example, the systems and methods can predict unexpected non-seasonal changes in demands of electric generators in association with tornados, or storms, so that a retail chain store can adjust its inventory accordingly in areas that are likely to be impacted to meet the volatile needs for such products. As another example, the systems and methods can predict changes in webpage visits or change in search volume of specific terms, so that webpage advertisement entities can adjust their advertising strategies accordingly to achieve optimal effect on their target audience. As yet another example, weather and climate hazards impact the travel industry. Predicting hazard impact can help travel agencies that rely on steady travel inventory (e.g. room bookings, flights, car rentals) to adjust their pricing or inventory accordingly to meet unexpected change in need for services. In addition, a user can utilize the systems and methods herein for predictions related to unmet needs or new opportunities. As an example, a prediction by the systems and methods about vegetation growth increase in a region may present an opportunity for initiating services in that region for a landscaping company to mitigate potential of a wildfire, for example. As another example, a prediction of foot-traffic increase may help a store to pick or deny a location to open a new store. Further, the systems and methods herein can also advantageously provide entities the tool to synergize supply chain management with marketing strategy in response to future events with an improved degree of accuracy than traditional technologies.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a conceptual architecture of an actionable insights platform disclosed herein.

FIG. 2 is a flowchart depicting an example process for utilizing prediction of future real-world events in connection with semantic information for generating actionable outputs for users in accordance with implementations of the present disclosure.

FIG. 3 depicts a computing system for generating actionable outputs utilizing prediction of future real-world events in connection with semantic information for generating actionable outputs.

Like reference numbers and designations in the various drawings indicate like elements.

### DETAILED DESCRIPTION

The technology of this patent application is directed to utilizing predictions of future real-world events in connection with semantic information to generate actionable decisions for a user in advance of occurrence of real-world events or conditions.

More particularly, the technology of this application includes processing predictions generated by machine learning (ML) models. Such prediction results may contain ancillary information associated with real-world natural events such as time window of occurrence and geo-spatial location of the event. The systems and methods herein may include receiving semantic information that a user can provide regarding products and/or services and related geolocations. Such semantic information can be matched using the technology of this application with some or all of the prediction results to generate recommendation outputs that may facilitate execution of actionable decisions by the user in preparation of the events.

Implementations of the present disclosure are described in further detail herein with reference to an example natural disaster, which includes wildfires. It is contemplated, however, that implementations of the present disclosure are applicable to any appropriate natural disaster.

To provide context for the subject matter of the present disclosure, and as introduced above, artificial intelligence (AI) and ML have been leveraged to generate predictions around natural disasters. For example, ML models can be used to generate predictions representative of characteristics of a natural disaster, such as likelihood of occurrence, duration, severity, spread, among other characteristics, of the natural disaster.

In further detail, one or more ML models can be trained to predict characteristics of a natural disaster using training data that is representative of characteristics of occurrences of the natural disaster, for example. The training data can include region data representative of respective regions (e.g., geographical areas), at which the natural disaster has occurred. In some examples, each ML model predicts a respective characteristic of the natural disaster. Example ML models can include, without limitation, a risk model that predicts a likelihood of occurrence of the natural disaster in a region, a spread model that predicts a rate of spread of the natural disaster in the region, a spread model that predicts a spread of the natural disaster in the region, and an intensity model that predicts an intensity of the natural disaster. Characteristics of a natural disaster can be temporal. For example, the risk of wildfire is higher in a dry season than in a rainy season. Consequently, each ML model can be temporal. That is, for example, each ML model can be trained using training data representative of regions at a particular period of time.

In further detail, the region data can include an image of the region and a set of properties of the region. More generally, the region data can be described as a set of data layers (e.g., N data layers), each data layer providing a respective type of data representative of a property of the region. In some examples, each data layer includes an array of pixels, each pixel representing a portion of the region and having data associated therewith that is representative of the portion of the region. A pixel can represent an area (e.g., square meters (m²), square kilometers (km²)) within the region. The area that a pixel represents in one data layer can be different from the area that a pixel represents in another data layer. For example, each pixel within a first data layer can represent X km² and each pixel within a second data layer can represent Y km², where X≠Y.

As an example, data layer can include an image layer, in which each pixel is associated with image data, such as red, green, blue (RGB) values (e.g., each ranging from 0 to 255). Another example layer can include a vegetation layer, in which, for each pixel, a normalized vegetation difference index (NVDI) value (e.g., in range of [−1, 1]). Other example layers can include, without limitation, a temperature layer, in which a temperature value is assigned to each pixel, a humidity layer, in which a humidity value is assigned to each pixel, a wind layer, in which wind-related values (e.g., speed, direction) are assigned to each pixel, a barometric pressure layer, in which a barometric pressure value is assigned to each pixel, a precipitation layer, in which a precipitation value is assigned to each pixel, and an elevation layer, in which an elevation value is assigned to each pixel.

Because values across the data layers can change over time, the region data can be temporal. For example, temperature values for the region can be significantly different in summer as compared to winter.

Accordingly, the region data can include an array of pixels (e.g., [p_{1,1}, . . . , p_{i,j}]), in which each pixel is associated with a vector of N dimensions, N being the number of data layers, i and j corresponding to column and row number of the pixel, respectively. For example, p_{i,j}=[I_{i,j}, V_{i,j}, W_{i,j}, . . . ], where I is image data, V is vegetation data, and W is weather data.

As training data, the region data, which can be referred to as region training data, can include one or more characteristic layers that provide known characteristic data for respective characteristics of a natural disaster. The known characteristic data represents actual values of the respective characteristics as a result of the natural disaster. For example, a wildfire can occur within a region and, as a result, characteristics of intensity, spread, duration, and the like can be determined for the wildfire. Accordingly, as training data, the region data can include, for example, p_{i,j}=[I_{i,j}, V_{i,j}, W_{i,j}, . . . , C_{A,i,j}^{K}, C_{B,i,j}^{K}, . . . ], where C_{A,i,j}^{K} and C_{A,i,j}^{K} are respective known (K) characteristics of a natural disaster in question.

One or more ML models are trained using the region training data. The training process can depend on a type of the ML model. In general, the ML model is iteratively trained, where, during an iteration, also referred to as epoch, one or more parameters of the ML model are adjusted, and an output (e.g., characteristic value) is generated based on the training data. For each iteration, a loss value is determined based on a loss function. The loss value represents a degree of accuracy of the output of the ML model as compared to a known value (e.g., known characteristic). The loss value can be described as a representation of a degree of difference between the output of the ML model and an expected output of the ML model (the expected output being provided from training data). In some examples, if the loss value does not meet an expected value (e.g., is not equal to zero), parameters of the ML model are adjusted in another iteration (epoch) of training. In some examples, the iterative training continues for a pre-defined number of iterations (epochs). In some examples, the iterative training continues until the loss value meets the expected value or is within a threshold range of the expected value.

To generate predictions, region data representative of a region, for which predictions are to be generated, is provided as input to a (trained) ML model, which generates a predicted characteristic for each pixel within the region data.

An example output of the ML model can include p_{i,j}=[C_{i,j}^{P}], where C is a characteristic predicted (P) by the ML model. Example characteristics can include, without limitation, likelihood of occurrence (e.g., risk), a rate of spread, an intensity, and a duration, a time window of occurrence, a geo-spatial location or region. In some examples, an image of the region can be displayed to visually depict the predicted characteristic across the region. For example, different values of the characteristic can be associated with respective visual cues (e.g., colors, shades of colors), and the predicted characteristic can be visually displayed as a heatmap over an image of the region.

While ML models are useful in generating predictions, natural disasters present a special use case for predictions using ML models. More particularly, various technical problems arise that must be addressed to utilize the predictions of natural events, e.g., disasters, so that the predictions can facilitate generation of accurate, reliable, and actionable decisions for users in preparation of natural events.

The prediction results, although including various characteristics of natural disasters, may not be directly meaningful or actionable for users. In particular, it is unclear to an entity (or a user) what aspects are going to be impacted by the occurrence of the natural event given the characteristics and how severe the impact will be. Further, what actionable items are more likely to be effective than others in preventing the impact (e.g., negative impact), given various constraints such as time, cost, and manpower.

In view of the foregoing, the methods and systems here provides a technical solution in utilizing the prediction results of the ML model(s) and generating actionable outputs in connection of semantic information provided by the user, so that the actionable outputs can be accurate, reliable items that the user can act on in advance of the occurrence of the natural disaster, therefore minimizing impact of natural disaster to the user, thus to people's daily life and entities daily operations.

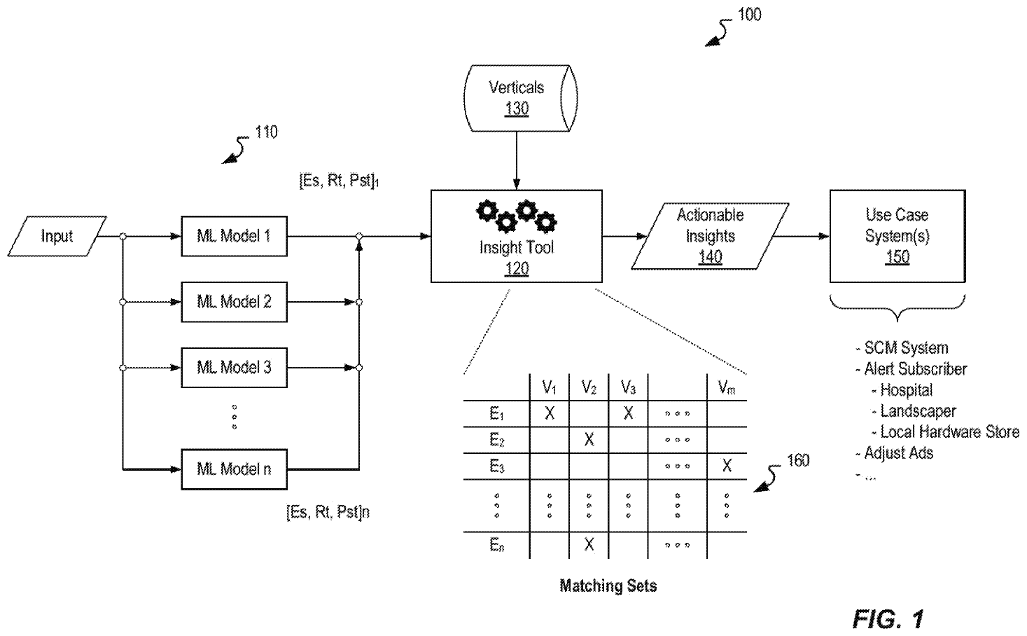

FIG. 1 shows a conceptual architecture of the actionable insights platform 100 for generating the actionable decisions for the entities or otherwise users. In the example of FIG. 1, the actionable insights platform 100 can include a set of ML models 110, an insight tool 120, one or more use case systems 150, and a verticals database 130.

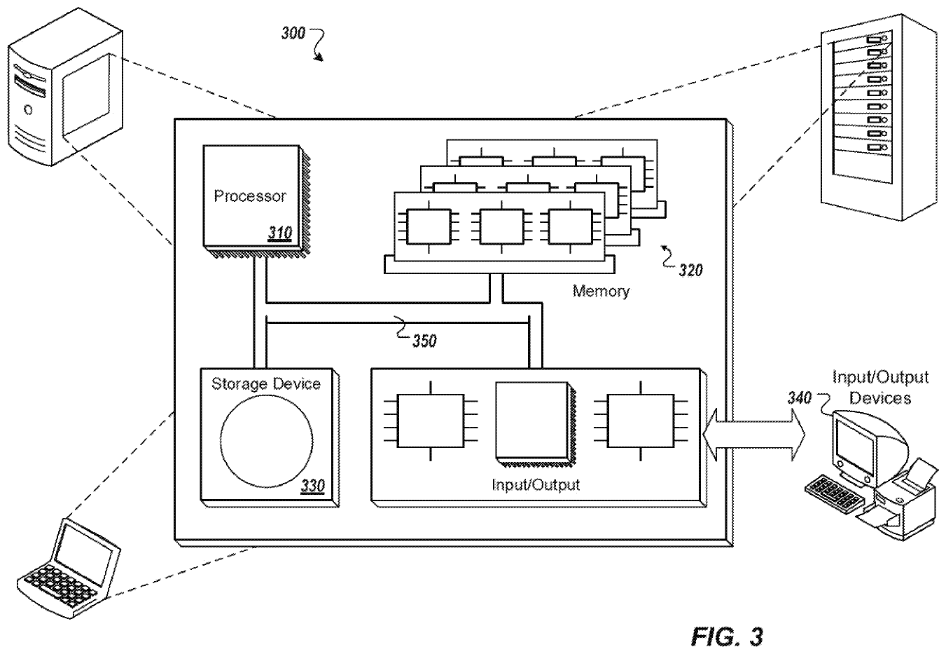

The set of ML models 110 may include a single ML model or a plurality of models. Each ML model can include computer programs, softwares, or applications that can be executable on various hardware including the computing system (300 in FIG. 3) disclosed herein.

Each ML model can model characteristics of a respective event (e.g., a natural disaster) as discussed herein. In some examples, a ML model can model a likelihood of the respective event (Eₛ) within a respective region (Rₜ), where s and t are integers greater than zero in a range of [1,m] and [1, n], respectively.

Example events and conditions can include, without limitation, a wildfire, a tornado, a hurricane, a heatwave, a blizzard, a flood, an earthquake, a volcano eruption, and the like. Example regions can include, without limitation, a neighborhood, a village, a town, a school district, a city, a county, a state, a province, and the like. In some implementations, the natural events or conditions can be various events that are non-seasonal or non-linear, thus less predictable by traditional forecasting methods. The natural events or conditions can include natural hazards or disasters. The natural events or conditions can include one or more meteorological events (e.g., storms, hurricanes, tornados, hail storms). The natural events or conditions may include events related to climate (e.g., wildfires, heat waves) and/or other earth-system based events (e.g., vegetation growth). In some implementations, the events or conditions are not limited to natural events, but may include various non-linear, non-seasonal changes or otherwise events hard-to-predict using traditional technologies (e.g., power outages).

In some implementations, one or more of the ML models 110 processes input data to generate a prediction, as disclosed herein. In some examples, the predication includes an event (Eₛ), a region (Rₜ), and a probability (Pₛₜ). For example, the prediction can indicate that there is the probability (Pₛₜ) that the event (Eₛ) will occur within the region (Rₜ). In some examples, the prediction can include ancillary data. Example ancillary data can include, without limitation, a severity of the event, a size of the event, a duration of the event, a time/date at which the event is expected to occur.

In some implementations, the prediction generated from one or more of the ML models 110 is provided as input to the insight tool 120.

In some implementations, the insight tool 120 is configured to pre-process the received prediction results to generate standardized prediction results. The standardized prediction results may include a standardized format that the insight tool 120 can directly process. The standardized format may be predetermined or adjusted manually or automatically based on the prediction results that are received.

Taken a wildfire as an example, the standardized prediction result may include: (1) a time window that the fire is going to occur in; (2) a geospatial area of predicted occurrence; (3) an intensity of the wildfire; and/or (4) an exposure level or probability of occurrence associated with (1), (2), (3) or their combinations. For example, a prediction result can include that a fast-moving wildfire may occur in October of 2024 in three different zip codes in California, exposing specific structures to damage. This predicted wildfire may last for 5-7 days.

In some implementations, the standardized prediction results may include information such as products, and/or services that the wildfire is going to impact. As an example, the standardized prediction results may include that personal protective equipment, home insurance, property insurance, and power supply are some among the products and services that are most likely to be impacted by this wildfire in 5 different zip codes within or in vicinity to the predicted wildfire.

In some implementations, the insight tool 120 processes a single prediction result or more than one prediction result to generate one or more actionable outputs 140.

The insight tool 120 may include software, computer programs, or applications as disclosed herein and hardware computing systems (e.g., 300 in FIG. 1) that the software, computer programs, or applications can be executed on.

In some examples, and as described in further detail herein, an actionable output 140 can include an action that is executable in response to a predicted event. The execution can be automatic, and directly performed by a user device in response to receive the actionable output. In some implementations, the actionable output may be forwarded to a user at a user device (e.g., via a graphic user interface (GUI)) for display. In accordance with such implementations, the action can be a recommended action, execution of which can be determined by one or more users.

In further detail, the insight tool 120 processes each prediction in view of data representative or semantic information of one or more verticals (V) provided from the verticals database 130 to generate the actionable insight(s) 140. Example verticals can include, without limitation, industries (e.g., landscaping, farming, personal protection equipment (PPE), healthcare, insurance, transportation) and entities (e.g., hospitals, stores, government agencies, hotels, emergency response units). Other exemplary verticals may include more specific information like a product or a service in one or more industries or related to certain entities.

In some implementations, the insight tool 120 may allow a user to input or select semantic information of one or more verticals to be combined with the prediction results to generate actionable outputs 140. The semantic information can include but is not limited to one or more industries, geospatial regions, products or services, or their categories that the user is interested in.

For example, a user may provide “insurance” as the industry, and then narrow down to “primary home insurance,” and inquire the insight tool 120 for recommendations about “primary home insurance” portfolio balancing and/or risk management in relation to wildfires. In other words, how a user might balance the risk across their portfolio of insurance policies for the coming year as the insight tool 120 predicts wildfire damage probabilities across a landscape. This may facilitate a more strategic set of actions by the user to acquire insurance policies in low risk areas to ‘balance’ those in high risk areas. As another example, a user may select personal protective supplies as related products, and the insight tool 120 may provide a prediction of demand increase in such personal protective supplies (e.g., face masks, goggles, gloves), facilitating a user to preemptively shift supply chain activities to account for this prediction. Such demand increase may be in percentage in comparison to an average baseline demand. In some cases, the prediction of product demand increase may be displayed against historical demand increase due to natural hazards such as wildfires.

As yet another example, a user may input or provide “search engine query volume” and then “search terms related to wildfire” for inquiring the insight tool 120 for recommendations or predictions. The tool 120 may provide estimated search increase and its change in time after the onset of a predicted wildfire, which could be used to dynamically price search bids according to real-world signals such as temperature. Each vertical, V1, V2, V3, may include one or more sub-verticals (e.g, V₁₁, V₂ₓ). For example, when V₁ is personal protection equipment, its sub-verticals can include goggles, face mask, disinfection wipes, etc.

The insight tool 120 may include a graphic user interface (GUI) that a user can interact with for inputting semantic information related to the verticals. The semantic information may be processed information based on user data that is available on the client device.

The insight tool 120 can match an event to one or more verticals. In the example of FIG. 1, an event E₁ is determined to be relevant to verticals V₁ and V₃, and an event V₂ is determined to be relevant to a vertical V₂. Accordingly, and in the example of FIG. 1, matching sets can be provided as [E₁, V₁], [E₁, V₃], [E₂, V₂], and so on.

The matching relationship between events and verticals may be derived from a predetermined mapping table 160. The mapping table 160 can be dynamically updated if needed. In some examples, the matching relationship may be determined by a user, for example, by manually selecting or entering one or more industries, entities, or products that are associated with an event (Eₛ). In some examples, the matching relationship may be automatically determined by the insight tool 120.

When the matching relationship is automatically determined, the insight tool 120 may import and analyze historical data related to the semantic information and match the historical data to historical natural events or conditions. As an example, historical sales data of various products from a retailer may be obtained, and the insight tool 120 may calculate a correlation of historical wildfire severity in a geo-spatial location with the sales data of personal protective supplies, like face masks, in time within the same region, and use the calculated correlation to predict demand increase of face masks and other protective products during time impacted by the predicted future wildfires.

To determine the matching relationship, in some implementations, the insight tool 120 may process prediction results generated by the ML models 110 to directly extract prediction information related industries, entities, or products/services. In other implementations, the insight tool may use a trained ML model to make inferences with respect to industries, entities, products or services that can be matched to one or more events. The ML model may be trained using historical data of events and impacted verticals as training samples. The insight tool 120 may use historical sales data or other information related to product or service demand to train the ML model for determining the matching relationship. The machine learning model can include but is not limited to a neural network.

As an example, when the historical events are wildfires, each training sample may be generated by including characteristics of the wildfire that can be derived from historical data. Such training samples can also include various verticals (e.g., search terms), and percentage of changes in search volume of such wildfire-related terms like facial masks, fire extinguisher, first aid, etc. in comparison to baseline average values. Each search term based on the percentage of change can include a training label as to whether the term can have a matching relationship or not with the wildfire. The ML model, once trained with historical data, can be used to predict various verticals, like industries, entities, products, or services that may be matched to a given event. Each of such predictions may be associated with an uncertainty rate that may be used as a factor to construct the mapping table 160.

As yet another example, either alone or in combination with other data processing and analysis methods disclosed herein, the insight tool 120 may derive user-specific sales data using statistical information. Such statistical information may be publicly available (e.g., from news or government reports). Instead of providing a large volume of historical sales data or statistics, a user may only need to input product category, type, or otherwise information that the recommendation can be provided on, and the insight tool 120 may use statistical information to generate the matching sets of events and verticals.

In some examples, for each matching set, the insight tool 120 determines whether to generate an actionable output 140. Whether an actionable output 140 is to be generated for a matching set can depend on one or more parameters of the event of the matching set 160. Example parameters can include, without limitation, a severity of the event, an imminence of the event (e.g., time until the event is expected to occur), and a probability of the event occurring. For example, a vertical can be associated with one or more parameter thresholds, to which the one or more parameters can be compared. In some examples, if a parameter meets or exceeds a respective threshold, an actionable insight is generated. For example, if a probability of the event occurring meets or exceeds a threshold probability associated with the vertical (to which the event is matched), an actionable insight 140 is generated. Otherwise, the actionable insight 140 is not generated. In some examples, if a parameter is less than a respective threshold, an actionable insight 140 is generated. For example, if an imminence of the event is less than a threshold imminence, an actionable insight 140 is generated.

In response to determine that an actionable output 140 can be generated, the insight tool 120 may generate actionable output(s) 140 based on the semantic information. In some implementations, the insight tool may use correlation, statistical information, or inference results to determine a quantitative value or qualitative estimate associated with each actionable output. For example, by detecting a strong correlation, (e.g., greater than a threshold) of historical wildfire with more than 10% increase in demand of facial mask than baseline demand, the insight tool may provide an actionable output with a 10% increase in demand. Alternatively, the actionable output may be decreasing the amount of web page advertisement or increasing staffing in a retail store.

In some cases, the semantic information can be used to select candidate actionable outputs that are directly or indirectly in correspondence therewith. Such selection can be from a predetermined list of actionable outputs. For example, when a user enters personal protection equipment as the semantic information, and a matching set of “wildfire” and “facial mask” has been determined. One or more actionable outputs can be selected from a predetermined list, which includes PPE or subvertical(s) of PPE. As an examples, the insight tool may select one or more actionable outputs from: (1) increase inventory of facial masks by 20% by September 2022 in 3 different retail stores that are closest to the predicted wildfire location; (2) increase staffing in 3 aisles in each of the impacted retail stores; (3) increase the order amount by 10% increase for N95 masks from manufacturer A; and (4) increase webpage advertisement about PPEs from August, 2022.

In some implementations, the insight tool 120 may generate actionable outputs 140 that include a probability score that indicates the recommendation confidence of the actionable output. The user can make decisions about execution of the actionable outputs based on the probability score. The probability score can include a value or range. As an example, when the recommendation is to increase the inventory of umbrellas, the probability score can be lower for rain lasting for less than a day but higher for rain lasting for several days or reaching a total of 10 inches precipitation. Different users may have different levels of sensitivities to the prediction confidence. The insight tool 120 may enable a user to customize sensitivity levels or confidence levels needed for one or more specific actionable outputs or for one or more vertical related outputs. For example, the insight tool 120 may be set by a user to ignore actionable outputs that are less than 50% confidence. Alternatively, the system may recommend the user to adjust a corresponding inventory by the amount that is only 50% of the predicted amount, if the user is less sensitive to prediction confidence. Over time, the system may pick up on the average threshold of a confidence level within a specific use case, such as retail sales.

The actionable output 140 can include a threshold of impact. The threshold of impact may allow a user to conveniently identify geo-spatial regions or areas that may be impacted and select regions that are more likely to be impacted. The geo-spatial regions can but may not necessarily overlap with the regions of the predicted event depending on the nature of the event. For example, a heat wave within a region can possibly impact that region and also other regions in its vicinity.

The actionable output 140 can include a geo-spatial region of various sizes that can be automatically determined or manually selected. For example, the region can be one or more pixels in a regional map. As another example, the region can include one or more buildings in a specific zip code. As yet another example, the prediction can line up with designated marketing areas.

The actionable output 140 can include a time window that is automatically determined or manually selected. The time window can be of various sizes, such as hours, days, weeks, or months, depending on the granularity of data output, or a user's responsiveness to the event. The time window can but may not necessarily overlap with that of the occurrence of the predicted event.

The actionable output may be communicated to one or more use case systems 150, either automatically or upon a user's request. Each use case system 150 may include a computing system (300 in FIG. 3). The use case system may allow a user to select one or more actionable outputs 140 for visualization (e.g., displayed within a GUI), so that the user can conveniently visualize the actionable output 140 in comparison to historical data of the user's interest. The GUI may be configured to display regular historical sales data of a product or service or historical search volume of a specific term or terms related to an event. The GUI may be configured to display historical change in sales data against one or more natural events or conditions. The GUI may also display differences in the regular historical data to the historical change caused by events or conditions. For the predictions or recommendations, the GUI may display them in relation to the one or more predicted events or conditions. A user can interact with the GUI for customized display. Over time, users within specific verticals who use the display to generate similar data outputs have the option to adopt a specific interface. For example, a user looking to determine the optimal location of their next retail outlet may be given the option to use an interface popular with users who have used the insight tool 120 for the same purpose, for example, regardless of location.

The use case system 150 may automatically take one or more actions upon receiving the actionable outputs 140 from the insight tool 120. For example, the use case system 150 may generate an alert to the user so that the user can take actions based on the alert. For example, a user can increase the inventory of umbrellas by 10% according to the actionable output 140. As another example, a user can adjust content of its webpage advertisement when the actionable output indicates a demand increase in rain jackets and umbrellas.

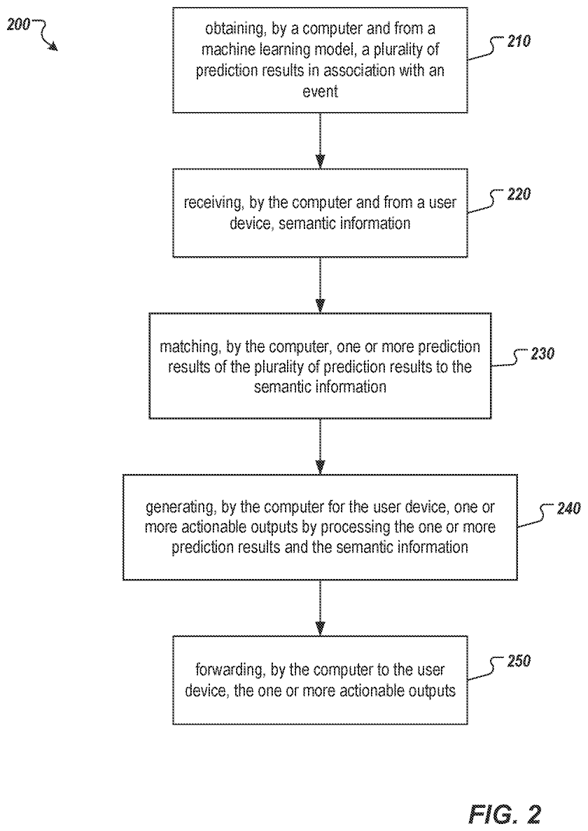

FIG. 2 is a flow diagram of an example process for generating actionable outputs for users in accordance with implementations of the present disclosure. For clarity of presentation, the description that follows generally describes method 200 in the context of the other figures in this description. However, it will be understood that method 200 can be performed, for example, by any system, environment, software, and hardware, or a combination of systems, environments, software, and hardware, as appropriate. In some implementations, various steps of method 200 can be run in parallel, in combination, in loops, or in any order.

At 210, a computing system (300 in FIG. 3) disclosed herein or equivalently, a computer, can obtain from a machine learning model (110 in FIG. 1) a plurality of prediction results generated by the machine learning model. The prediction results can be associated with an event disclosed herein. Each prediction result may include information as disclosed herein in correspondence to one or more events. The computing system can be part of the insight tool (120 in FIG. 1).

The prediction results may be obtained via a computer network or otherwise electronic communication pathways that allow data change between two computing systems. The computing system may obtain the plurality of prediction results based on a determination that a certain condition is met. For example, when it is determined that there are new prediction results generated by the ML model, or when there is a user's request for generation of actionable insights or output, the prediction results can be communicated to the computing system. The computing system may also obtain the plurality of prediction results based on a predetermined schedule, for example, once a day, once a week, month, or a fixed number of hours, etc.

At 220, the computing system or computer can receive from a user device, semantic information. The semantic information can correspond to one or more verticals provided in a verticals database (130 in FIG. 1). The semantic information may be input by a user via a GUI using an input device, and such user input may be communicated to the computing device.

In some implementations, the user may also provide information about an objective to be achieved in relation to the semantic information and one or more verticals. For example, a user may provide an estimated increase in demand for a particular product. The estimated increase can be expressed in user customized forms, such as a percentage increase over average, an absolute quantity change, an amount of change in revenue, etc.

At 230, the computing system or computer can match one or more prediction results of the plurality of prediction results to the semantic information. As a non-limiting example, the matching can be based on a predetermined mapping relationship (160 in FIG. 1) between the plurality of prediction results and the semantic information and/or the verticals. The matching step may be based on historical data of events or conditions. The matching may be performed by using a trained ML model that can infer one or more verticals that can be matched to even(s). For example, the trained ML model may indicate one or more industries, one or more entities within an industry, or one or more products or services within an industry that can be matched to one or more events. The matching may include a confidence score of the match.

In some implementations where there is a predetermined matching relationship, matching can be performed by using matching relationship and the semantic information or the verticals to find estimated events. As an example, a predetermined matching relationship can determine that an event “rain” can be matched to products as umbrellas and rain boots, and/or entities including but not limiting to convenience stores that sell such weather-associated accessories.

In other implementations where there is a trained ML model, the insight tool (120 in FIG. 1) may use verticals as input to infer possible events that can be matched to such verticals. As an example, the trained ML model may predict that rain boots and umbrellas can be matched to events of “raining.”

At 240, the computing system or computer may generate one or more actionable outputs for the user of the user device by processing the prediction results and the semantic information. The computing system or computer may determine whether actionable output can be generated or not. If it is determined that actionable output can be generated, for example, one or more parameter threshold has been met, the actionable output(s) can be generated. The generation of actionable outputs may include determining a quantitative value or qualitative estimate associated with each actionable output.

The generation of actionable outputs based on semantic information and prediction results may include determination of a correlation of one or more events with the semantic information, and generating an actionable output when the correlation is above a predetermined threshold. The one or more events can be historical events that correspond to the prediction results. The predetermined threshold can be automatically determined by the computing system. The generation of actionable outputs may include determining statistical information related to one or more events and/or the semantic information.

The generation of actionable outputs may include making inferences using a trained ML model about how likely the actionable outputs would occur given the prediction results and the semantic information. The ML model can be trained on historical data of events, for example, events that are similar to the predicted events, and the semantic information. The ML model may use historical data of actionable output as part of the training sample.

For example, the ML model may take different data as its inputs. The input data can include but is not limited to one or more pre-determined verticals or semantic information. For example, a supply chain of a product, a type of service. The input data to the ML model may also include information corresponding to an objective for that vertical or semantic information. Such an objective can be provided by a user, and optionally expressed as a target metric. As an example, the object can include a certain amount of revenue from a product or a target cost per acquisition of a new customer. The input data may also include historical data. For example, the historical data can include geospatial, for example, rain events with more than 10 inches of rain, and business data such as sales data of umbrellas over time in the past 3 years in a geospatial region.

With the inputs, the ML model can train itself and then make inferences. The historical data can be used as training samples, and information of the vertical/semantics can be used to find matching events. For example, in a matching relationship where “umbrella” is matched to “rain” and “snow,” the training samples can include historical sale data of umbrellas and geospatial data of heavy rain during a matched duration of time. The ML model can be trained to find correlation information between the vertical and the event in the historical data. The correlation can be one or more quantitative values, for example, a correlation curve over a certain time period.

In some implementations, the trained ML model may also make a prediction about a threshold for generating an actionable output. For example, the trained ML model may be provided with the inputs that the event of “rain” and the vertical “umbrellas” are connected. Then, the trained model can quantitatively estimate the correlation between rain and umbrella so that it can generate actionable outputs when the correlation satisfies a certain threshold. Such a threshold may only be satisfied when the duration of rain lasts for more than a couple days and the demand for umbrellas starts to increase more significantly than the increase that can be caused by rain showers with shorter durations. As another example, the trained ML model may determine that the demand of umbrellas and rain jackets increases with “rain” in winter but not as much in summer times.

At 250, the computing system or computer can forward the actionable outputs to the user device for presentation to the user. Such actionable output may be displayed to the user visually, for example, with graphical, textual, or numerical information.

FIG. 3 is a schematic diagram of a computer system 300. The system 300 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification and their structural equivalents, or in combinations of one or more of them. The system 300 is intended to include various forms of digital computers, such as laptops, desktops, workstations, servers, blade servers, mainframes, and other appropriate computers. The system 400 can also include mobile devices, such as personal digital assistants, cellular telephones, smartphones, and other similar computing devices. Additionally, the system can include portable storage media, such as Universal Serial Bus (USB) flash drives. For example, the USB flash drives may store operating systems and other applications. The USB flash drives can include input/output components, such as a wireless transducer or USB connector that may be inserted into a USB port of another computing device.

The system 300 includes a processor 310, a memory 320, a storage device 330, and an input/output device 440. Each of the components 310, 320, 330, and 340 are interconnected using a system bus 350. The processor 310 is capable of processing instructions for execution within the system 400. The processor may be designed using any of a number of architectures. For example, the processor 310 may be a CISC (Complex Instruction Set Computers) processor, a RISC (Reduced Instruction Set Computer) processor, or a MISC (Minimal Instruction Set Computer) processor.

In one implementation, the processor 310 is a single-threaded processor. In another implementation, the processor 310 is a multi-threaded processor. The processor 410 is capable of processing instructions stored in the memory 420 or on the storage device 430 to display graphical information for a user interface on the input/output device 440.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 400. In one implementation, the storage device 330 is a computer-readable medium. In various different implementations, the storage device 330 may be a floppy disk device, a hard disk device, an optical disk device, or a tape device.

The input/output device 340 provides input/output operations for the system 400. In one implementation, the input/output device 340 includes a keyboard and/or pointing device. In another implementation, the input/output device 340 includes a display unit for displaying graphical user interfaces.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers 300 suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Data processing apparatus for implementing machine learning models can also include, for example, special-purpose hardware accelerator units for processing common and compute-intensive parts of machine learning training or production (i.e., inference, workloads).

Machine learning models can be implemented and deployed using a machine learning framework (e.g., a TensorFlow framework, a Microsoft Cognitive Toolkit framework, an Apache Singa framework, an Apache MXNet framework).

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system 300 can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for utilizing predictions of future real-world events to make actionable decisions that prepare users for the real-world events, comprising:
obtaining, by a computer and from a machine learning model, a plurality of prediction results in association with an event;
receiving, by the computer and from a user device, semantic information;
matching, by the computer, one or more prediction results of the plurality of prediction results to the semantic information;
generating, by the computer for the user device, one or more actionable outputs by processing the one or more prediction results and the semantic information; and
forwarding, by the computer to the user device, the one or more actionable outputs, wherein the one or more actionable outputs comprise information that allows a user of the user device to act on in advance of occurrence of the event.

2. The computer-implemented method of claim 1, wherein each of the plurality of prediction results comprises one or more parameters of:
(1) the event;
(2) a time window that the event occurs;
(3) a geospatial area that the event occurs;
(4) an intensity of the event; and
(5) a probability of occurrence of the event corresponding to one or more of (2),
(3), and (4).

3. The computer-implemented method of claim 1, wherein matching, by the computer, the one or more prediction results of the plurality of prediction results to the semantic information is based on a predetermined mapping relationship between the plurality of prediction results and the semantic information.

4. The computer-implemented method of claim 1, wherein generating, by the computer for the user device, one or more actionable outputs by processing the one or more prediction results and the semantic information, comprises:
providing the one or more prediction results and the semantic information to a trained machine learning model; and
receiving an output from the trained machine learning model, including the one or more actionable outputs.

5. The computer-implemented method of claim 1, wherein the one or more actionable outputs is automatically executed by the user device.

6. The computer-implemented method of claim 1, wherein the one or more actionable outputs is displayed by the user device to a user using a graphic user interface (GUI).

7. The computer-implemented method of claim 1, wherein the event comprises a natural event or condition.

8. The computer-implemented method of claim 7, wherein the natural event or condition comprises a natural hazardous event.

9. The computer-implemented method of claim 1, wherein the semantic information comprises information corresponding to a product, a service, and/or a provider thereof.

10. The computer-implemented method of claim 1, wherein obtaining, by the computer and from the machine learning model, the plurality of prediction results in association with the event is based on the semantic information.

11. The computer-implemented method of claim 1, wherein generating the one or more actionable outputs by processing the one or more prediction results and the semantic information is in response to determining that at least one of the one or more parameters of the event satisfies a predetermined threshold.

12. The computer-implemented method of claim 1, wherein matching, by the computer, the one or more prediction results of the plurality of prediction results to the semantic information is by calculating a correlation between historical events and historical data in correspondence to the semantic information.

13. The computer-implemented method of claim 1, wherein matching, by the computer, the one or more prediction results of the plurality of prediction results to the semantic information is by using a machine learning model trained on historical events and historical data in correspondence to the semantic information.

14. A system comprising:
one or more computers and one or more storage devices storing instructions that are operable, when executed by the one or more computers, to cause the one or more computers to perform operations for utilizing predictions of future real-world events to make actionable decisions that prepare users for the real-world events, comprising:
obtaining, by a computer and from a machine learning model, a plurality of prediction results in association with an event;
receiving, by the computer and from a user device, semantic information;
matching, by the computer, one or more prediction results of the plurality of prediction results to the semantic information;
generating, by the computer for the user device, one or more actionable outputs by processing the one or more prediction results and the semantic information; and
forwarding, by the computer to the user device, the one or more actionable outputs, wherein the one or more actionable outputs comprise information that allows a user of the user device to act on in advance of occurrence of the event.

15. The system of claim 14, wherein each of the plurality of prediction results comprises one or more parameters of:
(1) the event;
(2) a time window that the event occurs;
(3) a geospatial area that the event occurs;
(4) an intensity of the event; and
(5) a probability of occurrence of the event corresponding to one or more of (2),
(3), and (4).

16. The system of claim 14, wherein matching, by the computer, the one or more prediction results of the plurality of prediction results to the semantic information is based on a predetermined mapping relationship between the plurality of prediction results and the semantic information.

17. The system of claim 14, wherein generating, by the computer for the user device, one or more actionable outputs by processing the one or more prediction results and the semantic information, comprises:
providing the one or more prediction results and the semantic information to a trained machine learning model; and
receiving an output from the trained machine learning model, including the one or more actionable outputs.

18. The system of claim 14, wherein the one or more actionable outputs is automatically executed by the user device.

19. The system of claim 14, wherein the one or more actionable outputs is displayed by the user device to a user using a graphic user interface (GUI).

20. A non-transitory computer-readable medium storing software comprising instructions executable by one or more computers which, upon such execution, cause the one or more computers to perform operations for utilizing predictions of future real-world events to make actionable decisions that prepare users for the real-world events, comprising:
obtaining, by a computer and from a machine learning model, a plurality of prediction results in association with an event;
receiving, by the computer and from a user device, semantic information;
matching, by the computer, one or more prediction results of the plurality of prediction results to the semantic information;
generating, by the computer for the user device, one or more actionable outputs by processing the one or more prediction results and the semantic information; and
forwarding, by the computer to the user device, the one or more actionable outputs, wherein the one or more actionable outputs comprise information that allows a user of the user device to act on in advance of occurrence of the event.
